(19) United States
(12) Patent Application Publication
(10) Pub. No.: US 2020/0275614 A1
(43) Pub. Date: Sep. 3, 2020

(54) Plant Supports and Methods of Using The Same

(71) Applicant: America's Gardening Resource, Inc., Burlington, VT (US)

(72) Inventor: Cody A. McKibben, Essex Junction, VT (US)

(21) Appl. No.: 16/752,003

(22) Filed: Jan. 24, 2020

Related U.S. Application Data
(60) Provisional application No. 62/811,979, filed on Feb. 28, 2019.

(51) Int. Cl. A01G 9/12; A01G 17/06; A01G 13/10

(52) U.S. Cl. CPC A01G 9/122; A01G 13/10; A01G 17/06

(57) ABSTRACT

Hinged plant support structures configured to support climbing plants are disclosed. For example, plant support structures formed from a plurality of elongate members having a zig zag or periodic waveform shape configured to be rotatably coupled to adjacent elongate members to form a support structure that includes a lattice of cells. In some examples, the elongate members may be configured, when in use, to act as cantilevered springs that allow a plant to sway in the wind, thereby strengthening the plant. In some examples, the plant supports are selectively configurable between open and closed configurations and have an adjustable size to allow for supporting different-sized plants. The support structures are also configured to easily collapse into a folded configuration for storage.

### RELATED APPLICATION DATA

This application claims the benefit of priority of U.S. Provisional Patent Application Ser. No. 62/811,979, filed Feb. 28, 2019, and titled “Plant Supports And Methods Of Using The Same,” which is incorporated by reference herein in its entirety.

### FIELD OF THE INVENTION

The present disclosure generally relates to the field of plant supports. In particular, the present disclosure is directed plant supports and methods of using the same.

### BACKGROUND

A variety of different plant support structures exist for supporting climbing plants, such as cucumbers, beans, tomatoes, eggplants, peas, peppers, and climbing vines. Plant support structures include cages and trellises. The plant can rest against, or on, and can grow around or up the plant support structure such that the plant support structure supports the plant above the ground and assists the growth of the plant.

### SUMMARY OF THE DISCLOSURE

In one implementation, the present disclosure is directed to a plant support, The plant support includes a plurality of elongate members that each have a waveform shape including a plurality of apexes; and a plurality of couplers, wherein ones of the plurality of couplers are removeably and rotatably coupled to corresponding ones of the apexes of at least two of the elongate members to form a plant support having at least one of a cage configuration, a wall trellis configuration, and a ladder with central column configuration.

In another implementation, the present disclosure is directed to a plant support kit, The plant support kit includes a plurality of elongate members having a plurality of bends that define a plurality of apexes, the plurality of apexes including first apexes located in a first plane along a first axis and second apexes located in the first plane and along a second axis that is substantially parallel to the first axis; and a plurality of couplers configured to releasably and rotatably couple together at least two of the elongate members at the first or second apexes.

In yet another implementation, the present disclosure is directed to a method of using a plant support, the plant support includes a plurality of elongate members that each have a waveform shape including a plurality of apexes and a plurality of couplers. The method includes constructing the plant support in a cage configuration by removably coupling together the elongate members by attaching ones of the couplers to the apexes of adjacent ones of the adjacent elongate members to form a substantially cylindrical cage configuration.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1 is a side perspective view of an example plant support structure of the present disclosure, shown in an enclosed self-supporting cage configuration arrangement and with a lower and upper module in a stacked configuration;

FIG. 2A is a side view of the plant support structure of FIG. 1, with the structure in an open configuration and with certain removable couplers removed;

FIG. 2B is a side view of the plant support structure of FIG. 1 shown in a wall trellis configuration against a vertical support structure;

FIG. 2C is a perspective view of a spacer for spacing a plant support from a vertical support structure;

FIG. 2D is an exploded view of a wall trellis spacer assembly including the spacer of FIG. 2C, one of the couplers from the plant support of FIG. 1, and a fastener for fastening the coupler and spacer to a vertical support structure;

FIG. 3 is a side view of the plant support structure of FIG. 1 and a side view of an example shorter single module plant support structure;

FIG. 4 is a top view of the single module plant support structure of FIG. 3;

FIG. 5 is a side view of the single module plant support structure of FIGS. 3 and 4 in a folded configuration;

FIG. 6 is a close-up view of a removable coupler attached to adjacent elongate members of a plant support structure;

FIG. 7A is a perspective view of the coupler of FIG. 6;

FIG. 7B is a top view of the coupler of FIGS. 6 and 7A;

FIG. 7C is a side view of the coupler of FIGS. 6, 7A, and 7B;

FIG. 7D is a front view of the coupler of FIGS. 6, 7A, 7B and 7C;

FIG. 8 is a side view of a plant support structure elongate member;

FIG. 9 is side views of top and bottom module elongate members;

FIG. 10 is a laid flat side view of two coupled elongate members;

FIG. 11A illustrates two removably coupled elongate members for a two-module plant support structure;

FIG. 11B is a larger scale detail view of the coupling interface of the elongate members of FIG. 11A;

FIG. 12A illustrates two removably coupled elongate members for a two-module plant support structure;

FIG. 12B is a larger scale detail view of the coupling interface of the elongate members of FIG. 12A;

FIG. 13 is a side view of an example plant support structure of the present disclosure, shown in a ladder with central column configuration and with a base, middle, and top module in a stacked configuration;

FIG. 14 is a larger-scale side perspective view of the plant support of FIG. 13;

FIG. 15 is a top view of the plant support of FIGS. 13 and 14;

FIG. 16A is a side view of one of the elongate members of the base module of FIG. 13;

FIG. 16B is a side view of one of the elongate members of the middle module of FIG. 13;

FIG. 16C is a side view of one of the elongate members of the top module of FIG. 13;

FIG. 17A is a perspective view of one of the couplers of the plant support structure of FIG. 13;

FIG. 17B is a top view of the coupler of FIG. 17A;

FIG. 18 is larger scale view of a portion of the plant support structure of FIG. 13 in a folded laid flat configuration;

FIGS. 19A-19D are front, side, perspective, and bottom views, respectively, of one example of a module coupler made in accordance with the present disclosure;

FIG. 20A shows elongate members and module couplers;

FIG. 20B is a detail view of a portion of FIG. 20A;

FIG. 20C is another detail view of a portion of FIG. 20A;

FIG. 21A shows a plant support that includes module couplers;

FIG. 21B is a detail view of a portion of FIG. 21A;

FIG. 22A shows elongate members and module couplers; and

FIG. 22B is a detail view of a portion of FIG. 22A.

### DETAILED DESCRIPTION

Aspects of the present disclosure include hinged plant support structures configured to support climbing plants. As described more below, plant support structures of the present disclosure may be formed from a plurality of elongate members having a zig zag or periodic waveform shape configured to be rotatably coupled to adjacent elongate members to form a support structure that in some configurations includes a lattice of cells. The elongate members may be configured, when in use, to act as cantilevered springs that allow a plant to sway in the wind, thereby strengthening the plant. In some examples, the plant supports are selectively configurable between open and closed configurations and have an adjustable size to allow for supporting different-sized plants. The support structures are also configured to easily collapse into a folded configuration for storage. In some examples, the plant supports are configured to be assembled into a ladder with central column configuration.

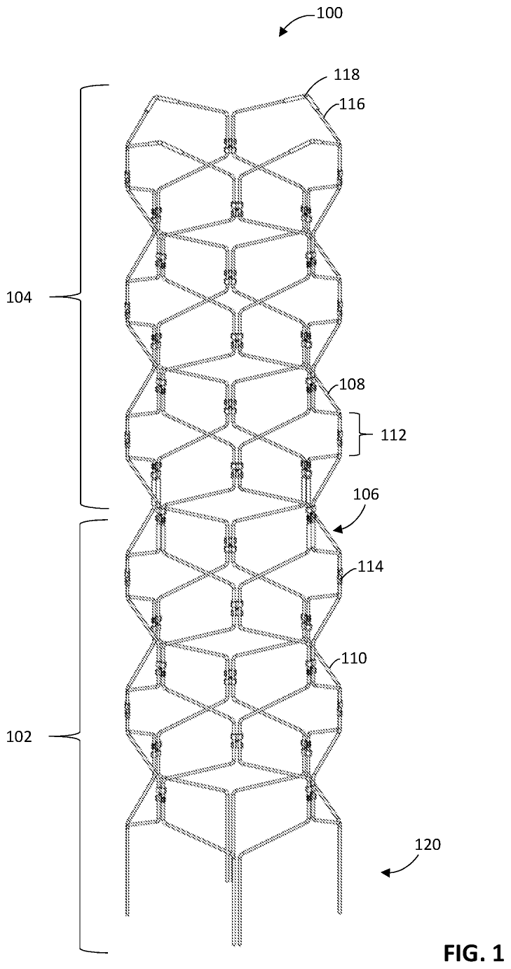

FIG. 1 illustrates one example of a plant support 100 including a base module 102 and a top module 104 slidably coupled together at interface 106. In the illustrated example, plant support 100 is arranged in a closed configuration, forming a self-supporting substantially cylindrical cage configuration that can be positioned around a plant to support the plant as it grows. Both the base and top modules 102, 104 are formed from a plurality of elongate members 108, 110, respectively (only one of each labeled) where at least a portion of each of the elongate members have a zigzag or periodic waveform shape. Adjacent elongate members 108, 110 are rotatably coupled at local maxima/minima or apexes 112 (only one labeled) of the elongate members' waveform shape, by couplers 114 (only one labeled). Top ends 116 (only one labeled) of adjacent elongate members 108 are joined in the illustrated embodiment by flexible sleeves 118. In the illustrated example, flexible sleeves 118 are silicone tubes configured to be bent and slidably disposed over ends 116. In other examples, support 100 may include rigid sleeves that are bent at a predefined angle for sliding over top ends 116. Elongate members 110 of base module 102 include a straight bottom section 120 (only one labeled) configured to be inserted into soil to anchor the plant support 100 in the ground.

In the illustrated example, elongate members 108, 110 are bent wires formed from 6061 aluminum. In other examples, the elongate members can be formed from wires or tubes made from any of a variety of other materials, such as galvanized wire or powder-coated steel wire. In yet other examples, elongate members may be formed from composite or polymer materials. In yet other examples, one or more of the elongate members can be a tube made from any of a variety of materials, including any of the foregoing materials. During use, elongate members 108, 110 are configured to act as cantilevered springs, with bottom section 120 fixed in soil and support 100 configured to sway or bend in response to external forces applied to the support, such as from wind. Couplers 114 may be designed and configured to allow for relative rotational and axial movement between the couplers and the elongate members to thereby allow the plant support 100 to resiliently bend along its longitudinal axis in response to external forces. FIG. 1 shows support 100 on a hard flat surface for illustration purposes. During use, in one example implementation, bottom section 120 is inserted fully or partially into soil. The strength of a plant's stem structure is increased when the plant is allowed to sway in the wind. Thus, the resilient construction of support 100, where a plant supported by the structure is allowed to move, increases the strength of the plant.

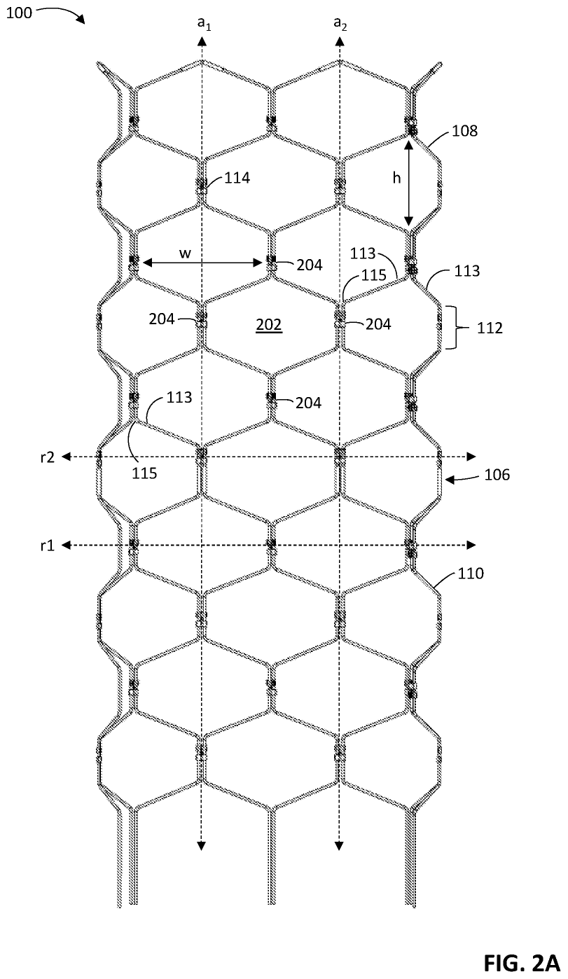

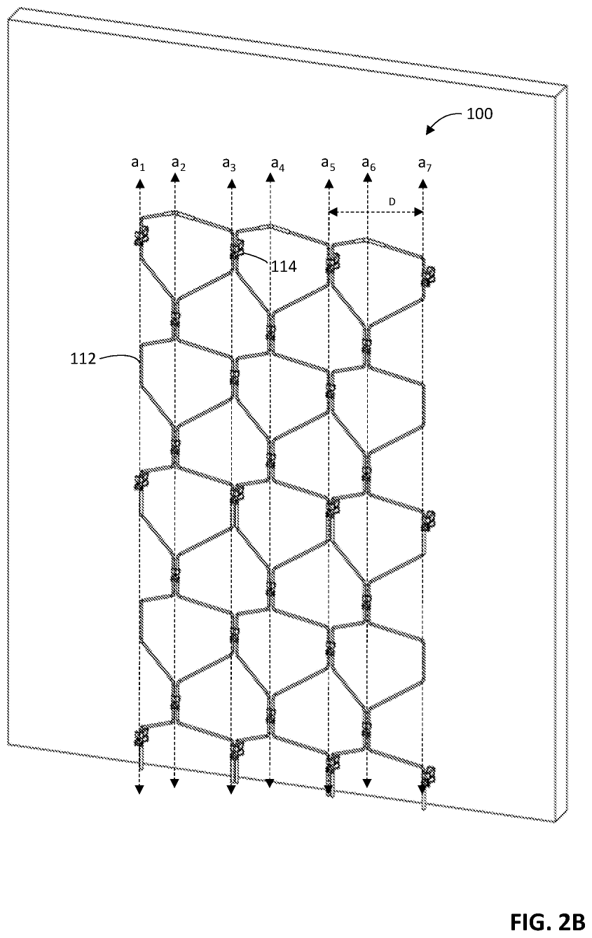

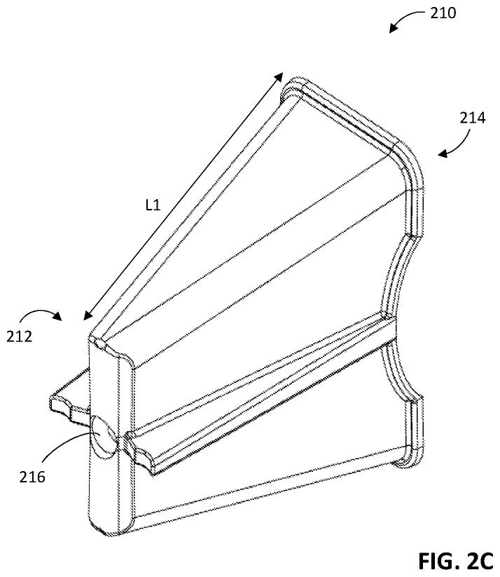

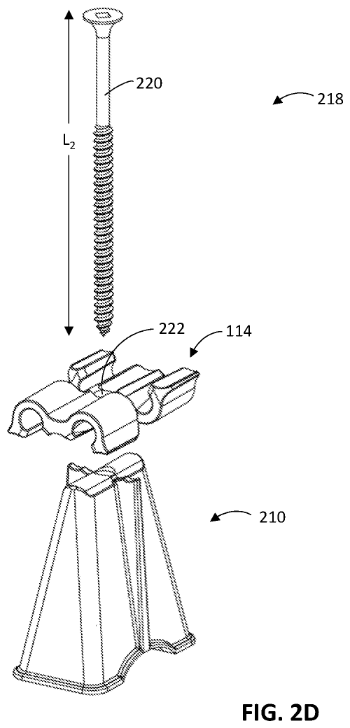

FIG. 2A shows plant support 100 in an open configuration. As shown in FIG. 2, at least a portion of elongate members 108, 110 have a zigzag or periodic waveform shape such that when coupled to adjacent elongate members, they form a lattice of cells 202 (only one labeled). In the illustrated example, cells 202 have a substantially hexagonal shape. In the open configuration the hinged connections define a matrix of rows and columns, each cell 202 being surrounded by four hinged connections 204. In the illustrated example, the elongate members 108, 110 include a plurality of substantially straight sections that define the local maxima/minima or apexes 112 and adjacent elongate members form hinged connections at the apexes 112. Elongate members 108, 110 also include transverse sections 113 that extend between the apexes 112 and bends 115 located between the transverse sections and apexes. In other examples, elongate members 108, 110 can have other shapes, such as a curved or serpentine shape, or a square wave shape, thereby forming a lattice of cells having a corresponding curved, square, or rectangular shape, respectively. In yet other examples, the elongate members may have a varying waveform shape where one or more of a shape or size of the sequential bends in the elongate members result in a shape that varies along the length of the elongate member. As shown in FIG. 2, hinged connections 204 are aligned along substantially parallel longitudinal axes (only two axes, a1, a2 labeled). Adjacent rows of the hinged connections 204 are located in substantially parallel rows (only two rows r1, r2 labeled). The hinged connections 204 in each row are offset, e.g., laterally or circumferentially, from the hinged connections in an adjacent row of connections, in the illustrated example, by half of a width w, of the cells 202. Hinged connections 204 in adjacent longitudinal axes, a, are also offset in an axial direction by a distance approximately equal to half of a height, h, of the cells. Cells 202 are configured to allow for easy access to plants supported by support 100 such that a gardener can easily reach in to adjust a position of the plant and to harvest fruit from the plant.

As described more below, couplers 114 are designed to be easily and quickly attached and removed from the elongate members 108, 110, such that support 100 can be transitioned from the closed configuration shown in FIG. 1 to the open configuration shown in FIG. 2A. In one example method of use, plant support 100 can be positioned around an existing plant and then closed to form a self-supporting structure for supporting the plant. Support 100 also has an adjustable and expandable configuration, where the number of elongate members 108, 110 can be increased or decreased as needed, to form substantially cylindrical support structures having a larger or smaller circumference and diameter for surrounding larger or smaller circumference and diameter plants.

As shown in FIGS. 2A and 2B, support 100 can also be transitioned into a wall trellis configuration, where the number of elongate members 108, 110 can be increased or decreased to lengthen or shorten the length of the wall trellis. FIG. 2B shows support 100 in a wall trellis configuration and positioned against a wall 206. Apexes 112 and couplers 114 located along longitudinal axes, a, can be alternatingly positioned against or spaced from the wall 206 to form a three-dimensional wall trellis structure that provides a spacing between climbing plants and the wall. In the example shown in FIG. 2B, apexes 112 and couplers 114 located along odd numbered axes a1, a3, a5, and a7 are positioned against wall 206 and apexes and couplers located along even numbered axes a2, a4, and a6 are spaced from the wall. The spacing of apexes 112 and couplers 114 from wall 206 can be selectively configured by adjusting a lateral distance, D (only one labeled), between the apexes and couplers in contact with the wall.

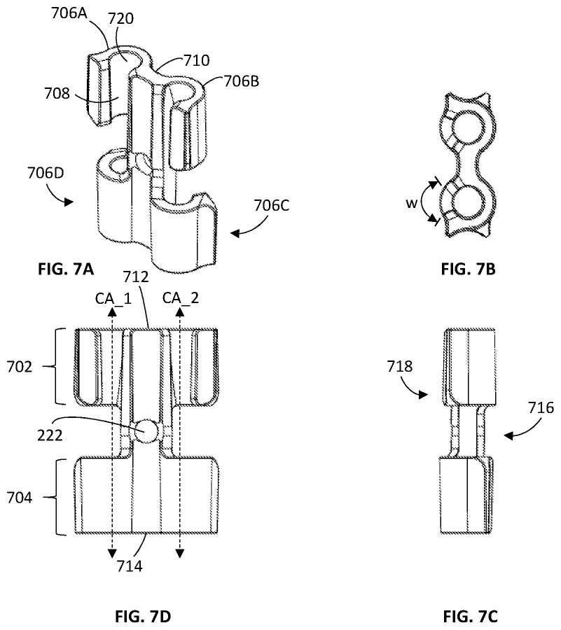

FIGS. 2C illustrates a spacer 210 that may be used to provide a spacing between support 100 and wall 206 or other vertical support structure, for example, when support 100 is in the wall trellis configuration shown in FIG. 2B. Spacer 210 includes a first end 212 configured to be positioned against ones of couplers 114 and a second end 214 configured to be positioned against a vertical support structure, such as wall 206. First and second ends 212, 214 are spaced by a length, L1, of the spacer to thereby provide a spacing of the length, L1, between the wall and the support structure. In the illustrated example, spacer 210 includes an opening 216 in first end 212 that, as shown in FIG. 2D, is designed and configured to receive a fastener 220 for attaching the spacer 210 and support 100 to a vertical support structure. FIG. 2D is an exploded view of a wall trellis spacer assembly 218 that includes fastener 220, one of couplers 114 and spacer 210. In the illustrated example, fastener 220 is a screw having a length L2 that is greater than length L1 of spacer 210 and that is configured to be positioned through opening 216 in the spacer, and opening 222 in coupler (see also FIG. 7D) and extend through an interior volume defined by the spacer and be secured to wall 206. Referring again to FIG. 2B, ones of spacers 210 can be positioned between one or more of couplers 114 located along the odd-numbered axes, a, that are positioned against wall 206 to thereby attach the wall trellis to the wall and also provide a spacing between support 100 and the wall to promote air flow between a climbing plant and the wall. One of fasteners 220 can be used to secure each coupler 114 and spacer 210 to the wall. In other examples, spacers 210 can be omitted and ones of couplers 114 can be directly attached to wall 206 by positioning fasteners 220 through openings 222 and into the wall.

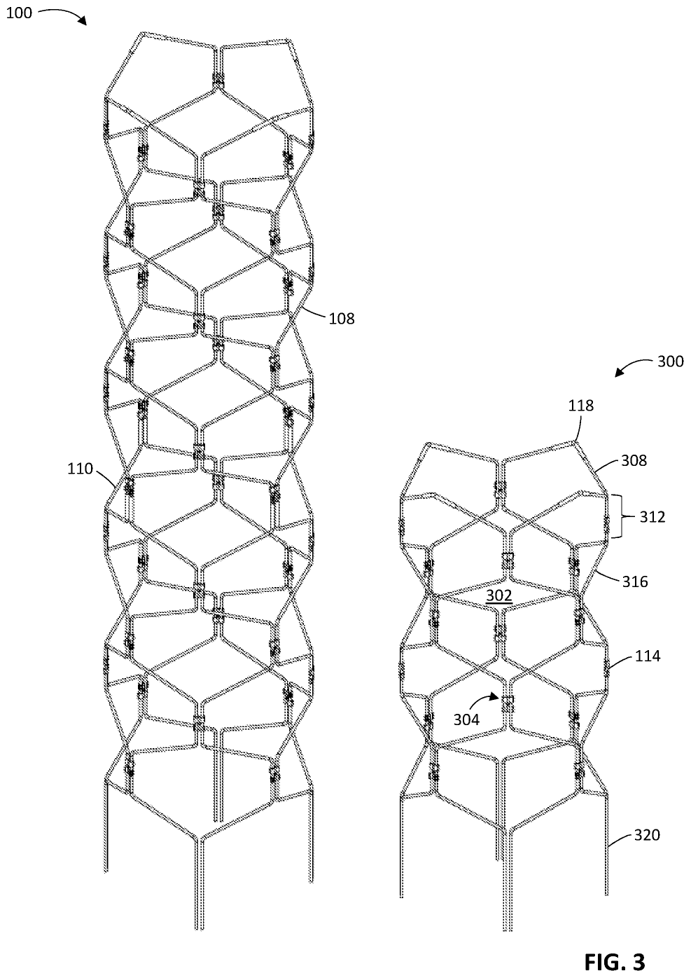

FIG. 3 illustrates plant support 100 in the cage configuration, which includes base module 102 and top module 104 in a stacked configuration as described above, and also illustrates a single module plant support 300 in a cage configuration, having a substantially similar construction as support 100. Support 300 includes a plurality of elongate members 308 having a similar construction as elongate members 108, 110, including a periodic waveform shape defining a plurality of apexes 312 configured to be coupled to the apexes of adjacent elongate members 308 by couplers 114 to form hinged connections 304 and a lattice of cells 302. Similar to plant support 100, top ends 316 (only one labeled) of adjacent elongate members 308 are joined in the illustrated embodiment by flexible sleeves 118. A straight bottom section 320 (only one labeled) is configured to be inserted into soil to anchor the plant support 300 in the ground. As with support 100, elongate members 308 are configured to act as cantilevered springs, with bottom section 320 configured to be fixed in soil and support 300 configured to sway or bend in response to external forces applied to the support, such as from wind. In other examples, plant supports made in accordance with the present disclosure can be formed from any number of stacked modules. For example, plant support 100 may be extended by adding another module of elongate members between base and top modules 102, 104. FIG. 4 is a top perspective view of plant support 300 in the cage configuration, illustrating the substantially cylindrical shape of the support in the cage configuration.

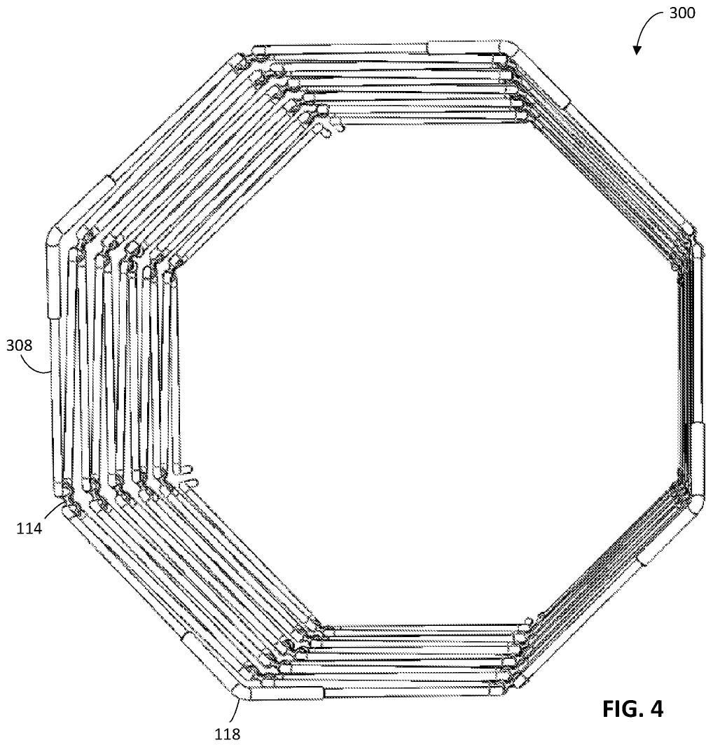

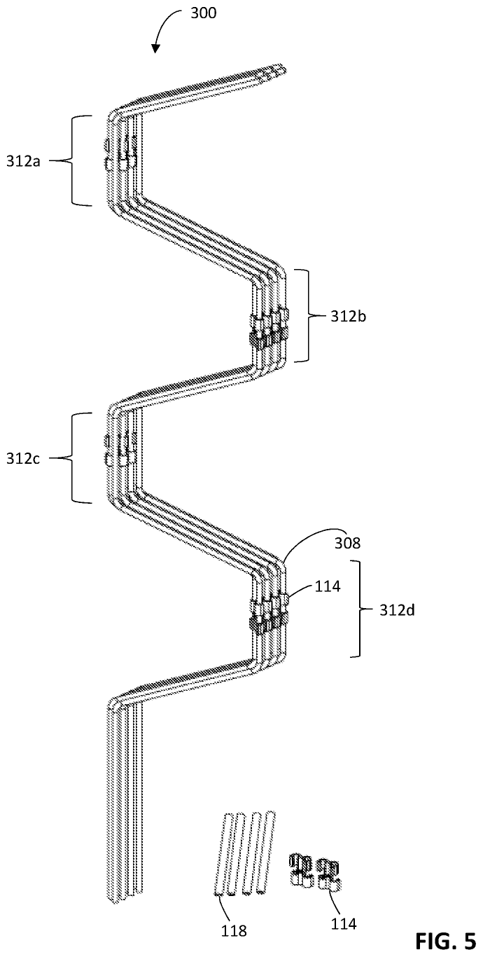

FIG. 5 shows plant support 300 in a folded laid flat configuration. In the illustrated example, to transition plant support 300 from the self-supporting cage configuration shown in FIGS. 3 and 4 to the folded configuration shown in FIG. 5, couplers 114 located along one of the longitudinal axes a_n (FIG. 1) joining two adjacent elongate members may be removed. In the illustrated example, elongate members 308 each have four apexes 312a-312d, with only two apexes being coupled to a given adjacent elongate member, such that only two couplers 114 must be removed to transition the support to a folded configuration (FIG. 5 illustrates the two removed couplers 114 at the bottom of the figure). Each of the flexible sleeves 118 may also be removed, as illustrated in FIG. 5, however, depending on the flexibility of the sleeves, this can be optional. After removing the two couplers 114, each of the elongate members can be rotated relative to adjacent members at the hinged connections formed by the remaining couplers 114 to collapse the support structure into the folded configuration shown in FIG. 5. Support structure 100 (FIG. 1) can similarly be easily and quickly transitioned to a folded configuration. In one example, steps for transitioning support structure 100 to a folded configuration include separating the base module 102 and the top module 104, removing one axial column of couplers 114 from each of the base and top modules, and then collapsing each of the modules into a folded configuration similar to the folded configuration shown in FIG. 5.

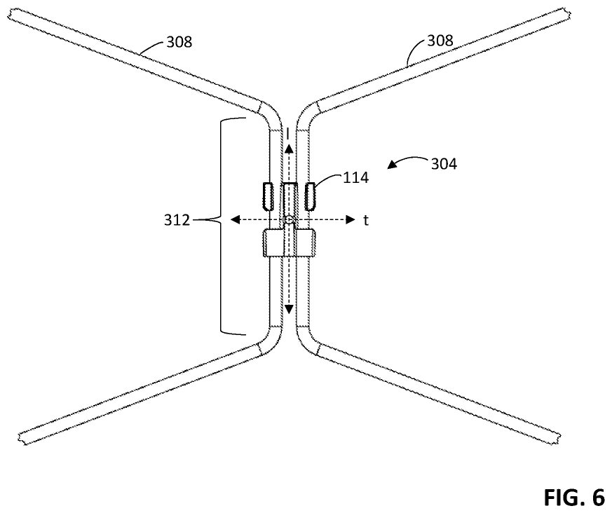

FIG. 6 illustrates a close-up view of one of couplers 114 coupled to one of apexes 312 of two adjacent elongate members 308. FIGS. 7A-7D further illustrate one of couplers 114. As best seen in FIG. 7A, coupler 114 includes two pairs 702, 704 of clips 706A-D having an open cross section defining openings 708. In the illustrated example, coupler 114 is a unitary member, with the two pairs 702, 704 of clips 706 extending from a central member 710 and facing opposite directions. Coupler 114 has a first end 712 and a second end 714, a first side 716 and a second opposing side 718, with the pairs 702, 704 being positioned in an opposing relationship with openings 708 of one pair of clips facing first side 716 and the openings of the second pair of clips facing second side 718. Each of clips 706 have an open cross section having a complementary shape to a cross-sectional shape of the elongate members and are formed from a resilient material, for example, nylon, e.g., nylon 6. In other examples, couplers 114 can be formed from any of a variety of other materials, such as polypropylene, ABS, polycarbonate, aluminum and/or composite materials. Each of clips 706 define an inner surface 720 (only one labeled) that has a complementary shape to an outer shape of elongate members 108, 110, or 308, in the illustrated example a circular shape. Clips 706 are sized to form an interference fit with the elongate members. The open cross sectional shape of clips 706 defines an opening having a width, w, (FIG. 7B). In the illustrated example, the width, w, of each clip 706 is sized to be less than an outer diameter of the elongate members such that the clip 706 resiliently expands when pressed over the elongate member and then resiliently clips into place around the elongate member. The pairs of clips 706 are designed and configured to position two elongate members in a parallel relationship with the apexes of the two elongate members rotatably disposed along parallel coupler axes CA_1 and CA_2. As described above in connection with FIGS. 2A-2D, coupler 114 also includes an opening 222 that extends through a thickness of the coupler between the first and second sides 716, 718, for receiving a fastener, such as fastener 220 (FIG. 2D) for securing the coupler to a vertical support structure, such as when the plant support is being used as a wall trellis.

Referring again to FIG. 6, coupler 114 can be selectively removeably attached from elongate members 308 by rotating the coupler about transverse axis, t, which is substantially perpendicular to central longitudinal axis, 1 and coupler axes CA_1 and CA_2. Once attached, coupler 114 forms a hinged connection 304 between elongate members 308, allowing the elongate members to rotate relative to each other. Couplers 114 enable the coupling of elongate members to form a plant support structure without the need for welded connections, which increases the durability and weather resistance of the structure and makes the structure more flexible to allow for swaying as described herein.

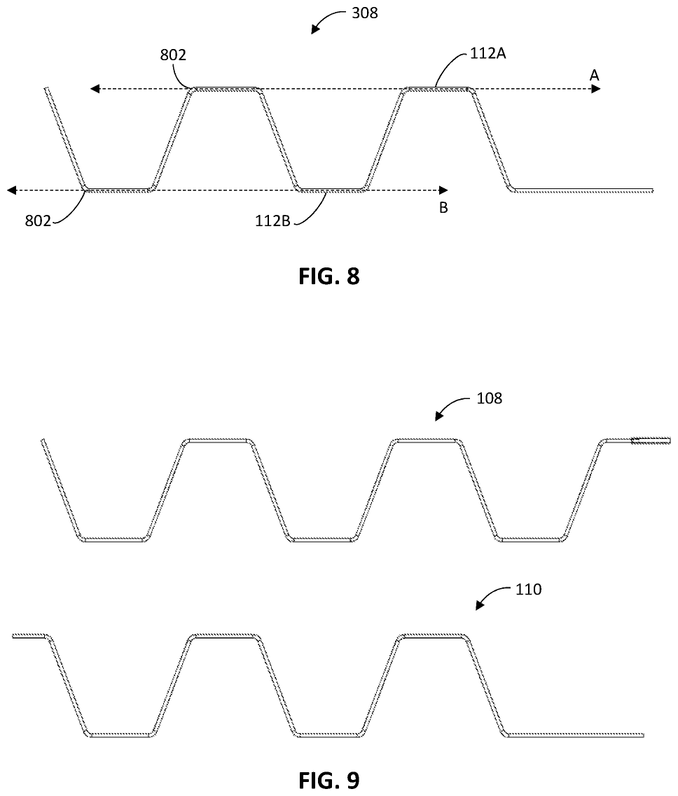

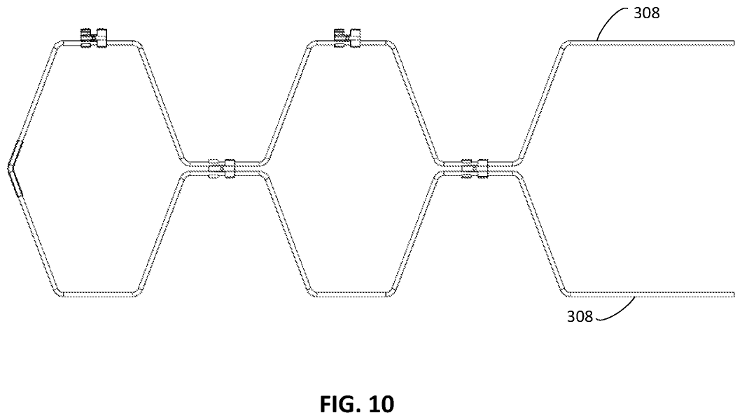

FIGS. 8-10 further illustrate elongate members 308, 108, and 110, with FIG. 10 providing dimensions (shown in inches) for one example. In one example, the illustrated dimensions of the portion of elongate members 108 and 110 that form a periodic waveform shape may be the same as the dimensions of the periodic waveform shape of elongate member 308. For example, both the elongate members of support 100 and support 300 define a lattice of cells 202, 302 having a substantially hexagonal shape that have a width that is roughly twice a height of the cells. As described above, in other examples, the elongate members can define any number of periodic shapes. As shown in FIG. 8, elongate members 308 include a plurality of bends 802 that define the plurality of apexes 112, the plurality of apexes including first apexes 112a (only one labeled) located in a first plane (e.g., the plane of the page in the illustrated example) along a first axis, a, and second apexes 112b (only one labeled) located in the first plane and along a second axis, b, that is substantially parallel to the first axis, a, the first and second apexes alternating along a length of the elongate member. As shown in FIGS. 9 and 10, elongate members 108 and 110 are similarly configured with a plurality of bends that define the plurality of apexes 112, the plurality of apexes including first apexes located in a first plane along a first axis and second apexes located in the first plane and along a second axis that is substantially parallel to the first axis the first and second apexes alternating along a length of the elongate member.

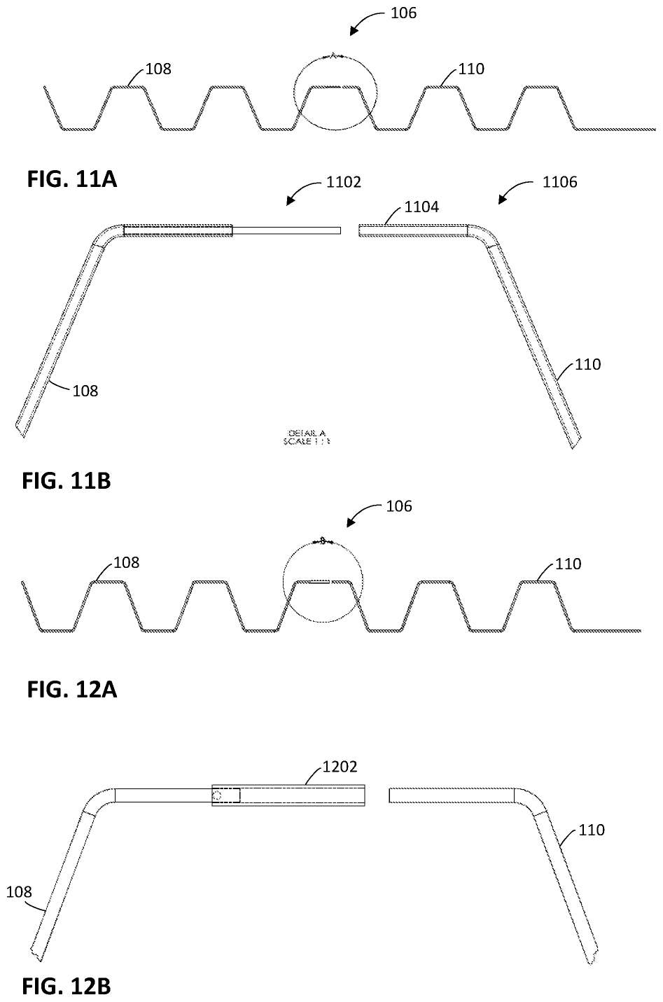

FIGS. 11 and 12 illustrate two example embodiments of interface 106 (see also FIG. 1) of elongate members 108 and 110. As shown in FIG. 11, in one example, at least a portion of elongate members 108 and 110 may be formed from tubes and a reduced diameter member 1102, such as a wire, may be fixed to one of the elongate members, e.g., 108 and be configured to be slidably inserted into a cylindrical recess 1104 defined by a top end 1106 of elongate member 110. In the example shown in FIG. 12 a tube section 1202 may be fixed, for example, by welding, to one of the elongate members, e.g., 108 and configured to be slidably disposed over the other elongate member, e.g. 110.

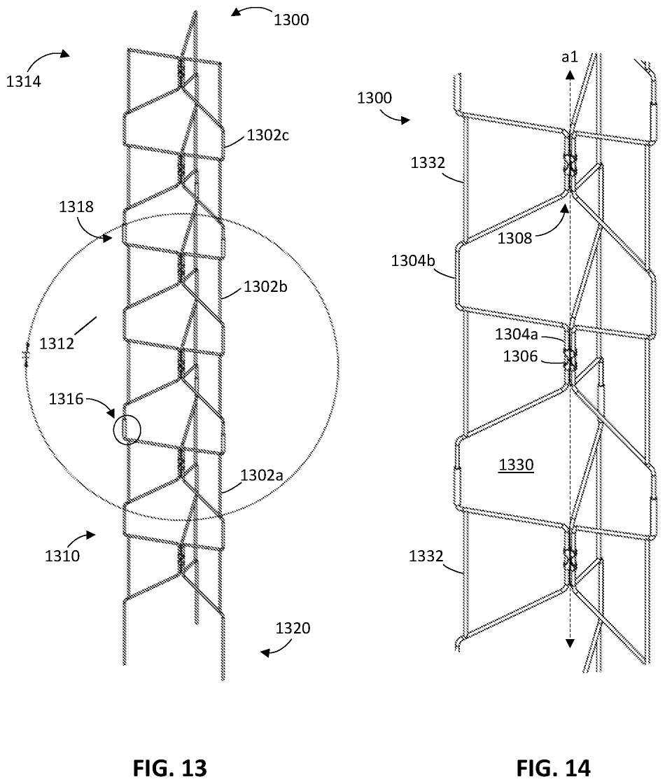

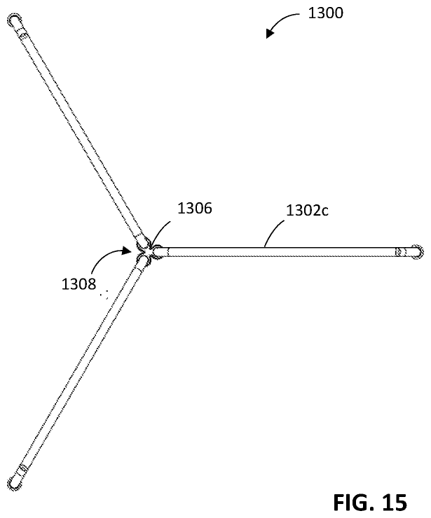

FIGS. 13-15 illustrate another example of a plant support 1300 made in accordance with the present disclosure, with FIG. 13 showing a side view, FIG. 14 showing a larger-scale side perspective view, and FIG. 15 showing a top view. Support 1300 has a similar construction to support 100 and includes a plurality of elongate members 1302a, 1302b, 1302c (only one of each labeled), that have a similar construction to elongate members 108, 110. Elongate members 1302 have a zigzag or periodic waveform shape that define local maxima and minima in the form of first apexes 1304a and second apexes 1304b (see FIG. 14). Adjacent elongate members are rotatably coupled at first apexes 1304a (FIG. 14) (only one labeled) of the elongate members' waveform shape, by couplers 1306 (only one labeled). As best shown in FIGS. 14 and 15, support 1300 has a ladder configuration that includes a central column 1308 extending along a central longitudinal axis al. As best seen in FIG. 15, the plurality of elongate members 1302 (three in the illustrated example) extend radially from the central column 1308. Referring again to FIG. 13, in the illustrated example, plant support 1300 includes a base module 1310, middle module 1312, and top module 1314 connected at interfaces 1316 and 1318 in a stacked configuration. Interfaces 1316, 1318 can have a similar configuration to interfaces 106 (FIGS. 1, 11, and 12) to allow for the modules to be slidably stacked. In the illustrated example, middle module 1312 may be removed and top module can be directly stacked on base module 1310 to provide a shorter-height support for shorter plants.

Elongate members 1302a of base module 1310 include an extended straight portion 1320 configured to be inserted into soil to anchor the plant support 1300 in the ground. Elongate members 1302 can be formed from similar materials as elongate members 108, 110, e.g., wire or tubing, and aluminium or steel, etc. as described above in connection with support 100 (FIG. 1).

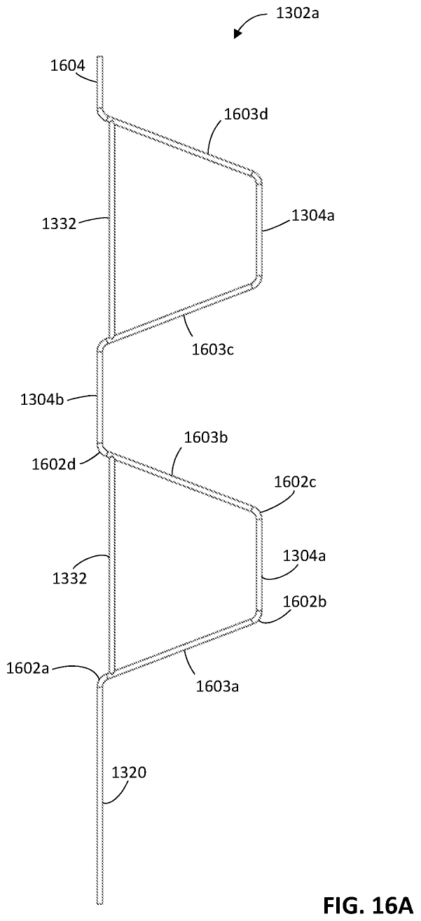

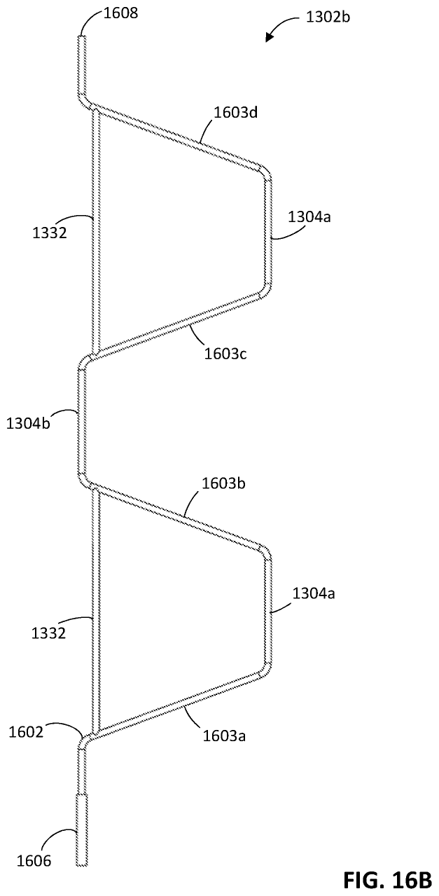

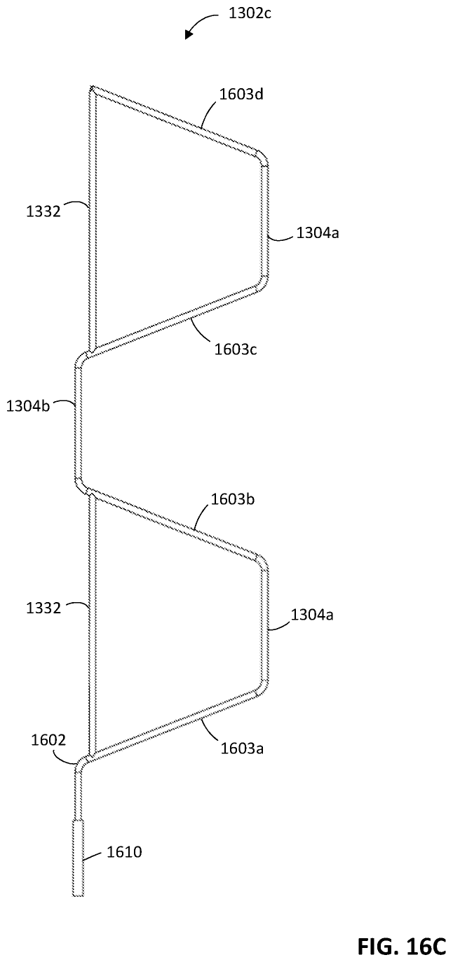

Unlike support 100, where ones of apexes 112 in each row are coupled to an apex of an adjacent elongate member, in support 1300, alternating rows of apexes 1304 are rotatably coupled to apexes of adjacent elongate members, defining a plurality of open volumes 1330 (only one labeled). Elongate members 1302 include additional support members 1332 that are positioned between second apexes 1304b, resulting in a more rigid structure as compared to elongate members 108, 110. FIGS. 16A-16C show side views of one of elongate members 1302a, 1302b, and 1302c, respectively. As shown in FIG. 16A, elongate member 1302a, which is designed and configured for forming base module 1310, includes an extended straight portion 1320 for insertion in soil, a plurality of bends 1602 that result in a waveform shape that includes two of first apexes 1304a and one second apex 1304b, and four transverse sections 1603 extending between the apexes 1304. Elongate member 1302a also includes a straight section 1604 configured to be inserted into a straight tube section 1606 of elongate member 1302b (FIG. 16B). Elongate member 1302a also includes two support members 1332 welded proximate bends 1602 on opposing sides of second apex 1304b. In the illustrated example, base module 1310 can be constructed by coupling three of elongate members 1302a together at first apexes 1304a using two couplers 1306.

As shown in FIG. 16B, elongate member 1302b, which is designed and configured for forming middle module 1312, includes straight tube section 1606 configured to receive straight section 1604 of elongate member 1302a, a plurality of bends 1602 (only one labeled) that result in a waveform shape that includes two of first apexes 1304a and one second apex 1304b, and four transverse sections 1603 extending between the apexes 1304. Elongate member 1302b also includes a straight section 1608 configured to be inserted into a straight tube section 1610 of elongate member 1302c (FIG. 16C). Elongate member 1302b also includes two support members 1332 welded on opposing sides of second apex 1304b. In the illustrated example, middle module 1312 can be constructed by coupling three of elongate members 1302b together at first apexes 1304a using two couplers 1306.

As shown in FIG. 16C, elongate member 1302c, which is designed and configured for forming top module module 1312, includes straight tube section 1610 configured to receive straight section 1608 of elongate member 1302b, a plurality of bends 1602 (only one labeled) that result in a waveform shape that includes two of first apexes 1304a and one second apex 1304b, and four transverse sections 1603 extending between the apexes 1304. Elongate member 1302c also includes two support members 1332 welded on opposing sides of second apex 1304b. In the illustrated example, top module 1314 can be constructed by coupling three of elongate members 1302c together at first apexes 1304a using two couplers 1306.

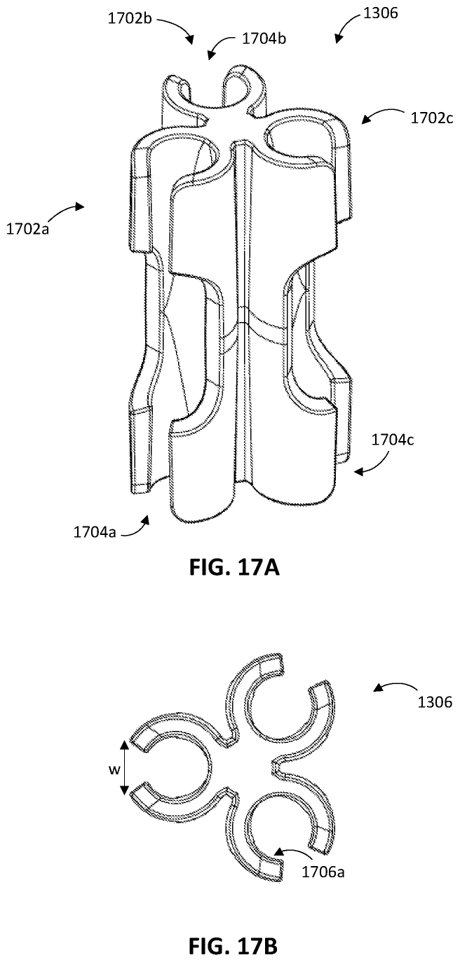

FIGS. 17A and 17B illustrate coupler 1306, with FIG. 17A showing a perspective view and FIG. 17B showing a top view. Coupler 1306 has a similar design to coupler 114 (FIGS. 7A-7D) in that coupler 1306 includes clips 1702a-1702c that each include openings 1704a-1704c and an open cross section having a complementary shape to a cross-sectional shape of elongate members 1302 and are formed from any of the resilient materials described above in connection with couplers 114, such as nylon, polypropylene, ABS, polycarbonate, aluminum and/or composite materials. Each of clips 1702 define an inner surface 1706 (only one labeled) that has a complementary shape to an outer shape of elongate members 1302, in the illustrated example a circular shape. Clips 1702 are sized to form an interference fit with the elongate members. The open cross sectional shape of clips 1702 defines an opening having a width, w, (only one labeled in FIG. 17B). In the illustrated example, the width, w, of each clip 1704 is sized to be less than an outer diameter of the elongate members such that the clip 1704 resiliently expands when pressed over the elongate member and then resiliently clips into place around the elongate member.

Coupler 1306 includes three clips 1702 positioned in a parallel relationship and equally spaced circumferentially around a central longitudinal axis of the coupler and configured to couple to the apexes 1304 of three elongate members 1302 so that the apexes, e.g., first apexes 1304a, of the elongate members are positioned in a parallel relationship and equally spaced circumferentially as shown in FIG. 14. Couplers 1306 are designed and configured to be quickly and easily coupled and decoupled from elongate members 1302 so that a plant support such as support 1300 can be quickly and easily constructed and deconstructed.

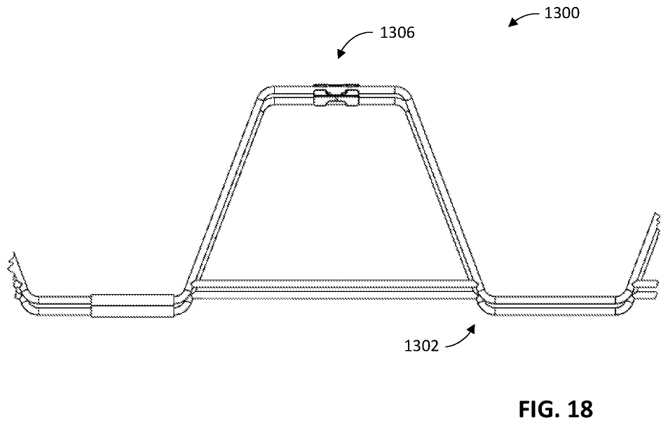

FIG. 18 is a larger-scale view of a portion of support 1300 shown in a folded configuration. Couplers 1306 are configured to allow relative rotational movement between the elongate members 1302 and the couplers so that support 1300 can be easily transitioned from the expanded configuration shown in FIG. 13 to the folded configuration shown in FIG. 18 without needing to remove any of the couplers 1306 by simply rotating and folding the elongate members together. As shown in FIG. 18, in the folded configuration, the footprint or two-dimensional area and the space envelope or three-dimensional area taken up by the entire assembled support is substantially the same or similar to the footprint and space envelope of one of the elongate members 1302. Support 1300 can, therefore, be quickly and easily stored and deployed and takes up minimal space during storage.

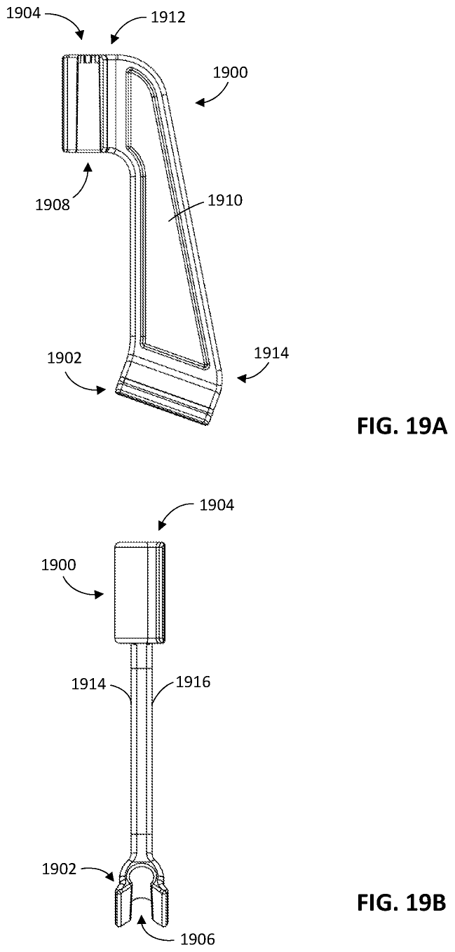

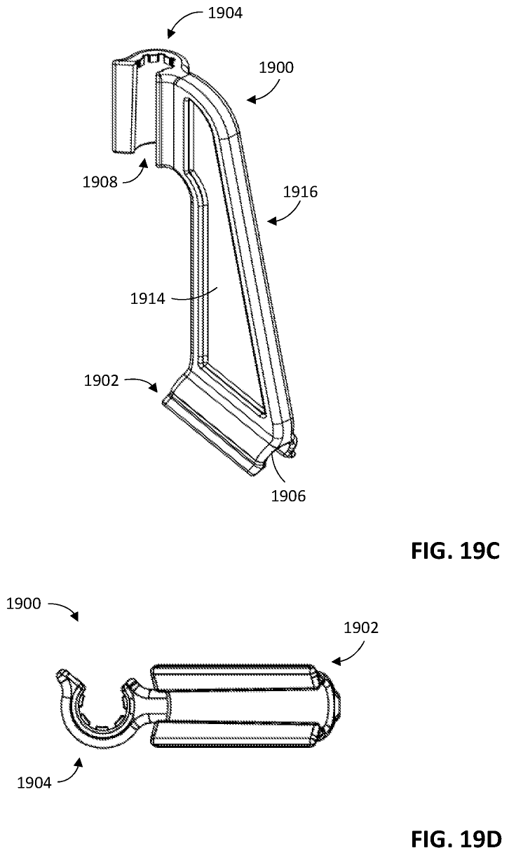

FIGS. 19A-19D illustrate front, side, perspective, and bottom views, respectively, of one example of a module coupler 1900 made in accordance with the present disclosure. Module coupler 1900 is configured to couple together adjacent modules of plant supports of the present disclosure, such as modules 102 and 104 (FIG. 1), modules 1310 and 1312, or modules 1312 and 1314 (FIG. 13). As described above, plant supports of the present disclosure may include a plurality of modules that can be stacked together to increase a height of the support structure. In some examples, the modules are configured to be slidably coupled together, which can facilitate ease of assembly and disassembly of the modules. Module coupler 900 is configured to prevent unwanted or inadvertent separation of adjacent modules, for example, when moving or adjusting the support structure, or due to windy conditions, which may cause the support structure to sway in the wind to the point of adjacent modules becoming decoupled.

Module coupler 1900 includes a first clip 1902 configured to be removably and rotatably coupled to transverse section 113 (FIG. 1) or 1603 (FIGS. 16A-16C) and a second clip 1904 configured to be removably and rotatably coupled to tube sections 1202 (FIGS. 12A, 12B) or 1606 or 1610 (FIGS. 16B, 16C). Each of clips 1902, 1904 have a corresponding opening 1906, 1908 sized to be pressed over and resiliently clipped to a portion of an elongate member in a similar fashion to clips 706 of coupler 114 (FIGS. 7A7D) and clips 1702 of coupler 1306 (FIGS. 17A and 17B). Module coupler 1900 may be made from any of the materials described above in connection with couplers 114 and 1306. Module coupler 1900 is a unitary member that includes a body 1910 extending between clips 1902 and 1904, the body having a first end 1912 and a second end 1914, a first side 1916 and a second opposing side 1916. As shown in FIGS. 19A-19D, opening 1908 is selectively located on one of sides 1914/1916, so that first clip 1902 can be coupled to a transverse section of an elongate member and then coupler 1900 can be rotated about the transverse section to couple second clip 1904 to a portion of an elongate member apex, such as tube sections 1202 (FIGS. 12A, 12B) or 1606 or 1610 (FIGS. 16B, 16C). Such a configuration facilitates ease of use by allowing coupler 1900 to remain coupled to a transverse section while selectively coupling or decoupling second clip 1904 from the apex of an adjacent plant support module.

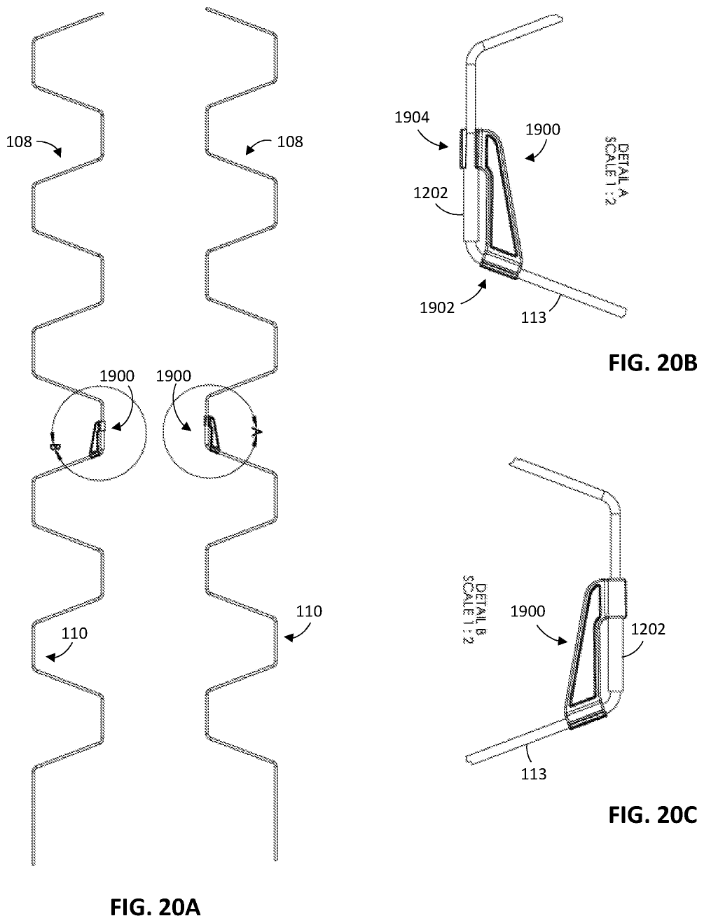

FIGS. 20A-20C show module coupler 900 in use with elongate members 108 and 110 of plant support 100 for coupling base module 102 and top module 104. Module coupler 1900 is shown coupled to tube section 1202 of elongate member 108 and transverse section 113 of elongate member 110 to prevent the elongate members 108, 110 from sliding apart and becoming decoupled, for example, in heavy winds. In use, first clip 1902 can be coupled to transverse section 113 and then the coupler can be rotated about the transverse section in a first rotational direction to engage and couple second clip 1904 to tube section 1202. For disassembly, module coupler 1900 can be rotated about transverse section 113 in a second rotational direction opposite from the first rotational direction to decouple second clip 1904 from tube section 1202.

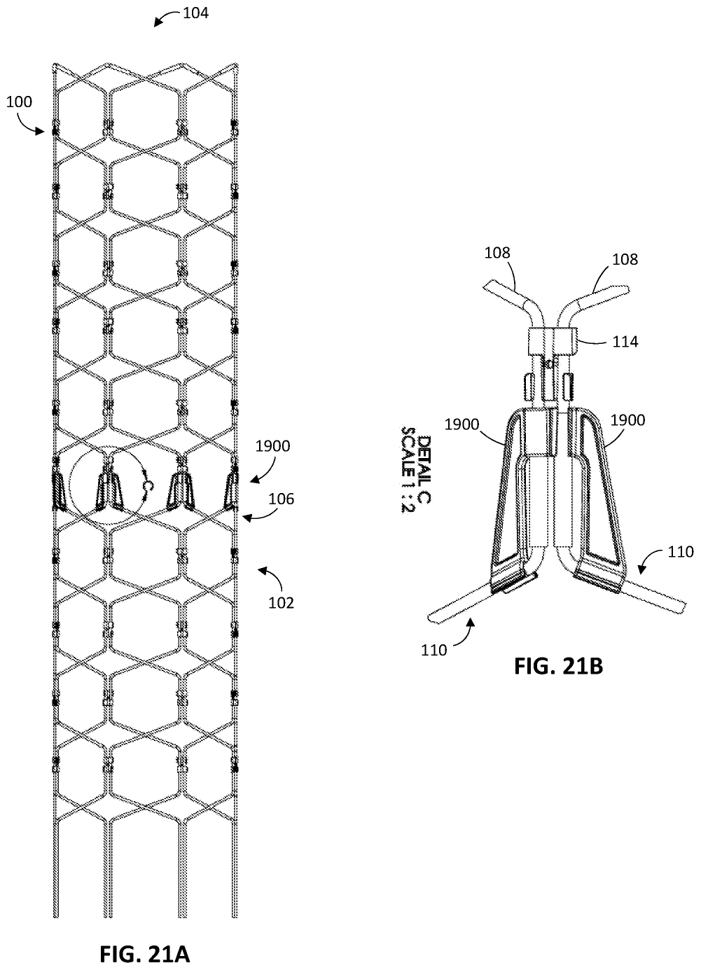

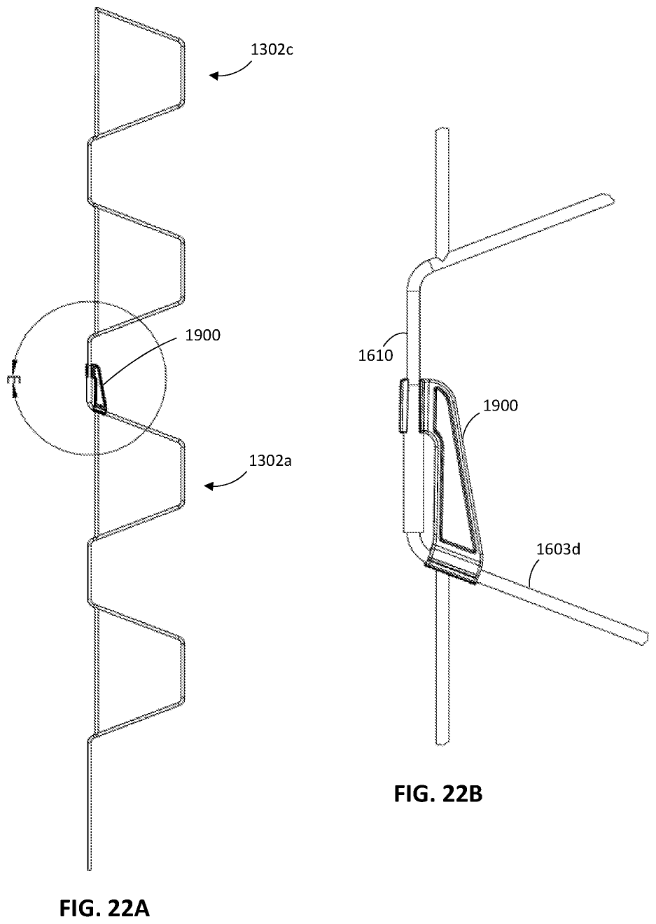

FIGS. 21A and 21B show a plurality of the module couplers 900 in use with a fully assembled plant support 100, with one module coupler used to couple each pair of elongate members 108, 110. In other examples, less couplers 1900 may be used for coupling modules 102 and 104, for example, two disposed on opposing sides of support 100, or more as needed. FIGS. 22A and 22B show module coupler 900 in use with elongate members 1302a and 1302c of plant support 1300 for coupling base module 1310 and top module 1314. Module coupler 1900 is shown coupled to tube section 1610 of elongate member 1302c and transverse section 1603d of elongate member 1302a to prevent the elongate members from sliding apart and becoming decoupled, for example, in heavy winds.

Components of the various examples disclosed herein may be modified and combined any a variety of ways. For example, elongate members 108, 110, and 308 (FIGS. 1-3) which are shown assembled in a cage configuration (FIGS. 1 and 3) and wall trellis configuration (FIG. 2) may be used to form a plant support in the form of a ladder with central column configuration as shown in FIG. 13 by replacing couplers 114 with couplers 1306 and attaching the elongate members 108, 110, or 308 to the couplers 1306 in the manner shown in FIGS. 13 and 14. Further, elongate members 108, 110, and 308 may be modified to include additional support members extending between apexes 112 in a similar manner to supports 1332 shown in FIGS. 13 and 14 to increase the rigidity of the elongate members. Similarly, elongate members 1302 from support 1300 may be assembled into a cage configuration or wall trellis configuration in a similar manner to the examples shown in FIGS. 1-3 by coupling together the elongate members 1302 in the manner shown in FIGS. 1-3. In some examples, couplers 1306 may be used in place of couplers 114 to construct a cage or wall trellis by coupling elongate members to only two of the three clips1702 and leaving one of the clips open and unused. In some examples, couplers 1306 can be modified to couple to spacers 210 (FIGS. 2C, 2D), for example, by forming a hole through the coupler 1306 that is perpendicular to the central longitudinal axis of the coupler that is configured to receive a fastener, such as fastener 220. In other examples, spacers 210 may be modified to couple to couplers 1306, such as by including an additional opening that extends through the sides of the spacer, for example, in a direction substantially perpendicular to a central axis of opening 216, and that is configured to receive a securing member, such as a zip tie for securing coupler 1306 or elongate member to the spacer 210. Thus, coupler 1306 can be used to form a cage (FIG. 1) wall trellis (FIG. 2B) or ladder with central column (FIG. 13) with elongate members 108, 110, 308 or 1302.

The foregoing has been a detailed description of illustrative embodiments of the disclosure. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure. It will be understood by those skilled in the art that various changes, omissions and additions may be made to that which is specifically disclosed herein without departing from the spirit and scope of the present disclosure.

What is claimed is:

1. A plant support, comprising:
a plurality of elongate members that each have a waveform shape including a plurality of apexes; and
a plurality of couplers, wherein ones of the plurality of couplers are removeably and rotatably coupled to corresponding ones of the apexes of at least two of the elongate members to form a plant support having at least one of a cage configuration, a wall trellis configuration, and a ladder with central column configuration.

2. The plant support of claim 1, wherein the plurality of couplers are configured to be selectively releasably coupled to the plurality of elongate members to selectively configure the plant support in either the cage configuration or the wall trellis configuration.

3. The plant support of claim 2, wherein the cage configuration includes the plurality of elongate members positioned in a substantially parallel relationship, the apexes of the elongate members coupled to the apexes of adjacent ones of the elongate members with ones of the couplers, the couplers defining a plurality of rows of hinged connections.

4. The plant support of claim 3, wherein the couplers are designed and configured to allow for relative rotational and axial movement between the couplers and the elongate members to thereby allow the plant support to resiliently bend along a longitudinal axis of the plant support.

5. The plant support of claim 3, wherein adjacent ones of the rows of hinged connections are circumferentially offset.

6. The plant support of claim 3, wherein the couplers define a plurality of columns of the hinged connections, wherein the plant support is configured to be selectively transitioned from the cage configuration to either the wall trellis configuration or a folded laid flat configuration by decoupling two adjacent elongate members along one of the plurality of columns.

7. The plant support of claim 6, wherein the folded laid flat configuration includes a stacked arrangement of the plurality of elongate members rotatably coupled together.

8. The plant support of claim 6, wherein the plant support is designed and configured for a diameter of the cage configuration to be adjusted by decoupling two adjacent elongate members along one of the plurality of columns and selectively adding or removing one or more of the plurality of elongate members to increase or decrease the diameter of the cage.

9. The plant support of claim 2, wherein ones of the plurality of couplers include resilient clips for releasably coupling to the elongate members.

10. The plant support of claim 9, further comprising a plurality of wall trellis spacer assemblies, each of the plurality of wall trellis spacer assemblies including a spacer for positioning ones of the couplers away from a vertical support structure and a fastener for fastening the coupler and the spacer to the vertical support structure.

11. The plant support of claim 10, wherein ones of the plurality of couplers include an opening located between the resilient clips configured to receive one of the fasteners for attaching the coupler to the spacer.

12. The plant support of claim 2, wherein the plurality of couplers are configured to be selectively coupled to the plurality of elongate members to selectively configure the plant support in to each of the cage configuration, the wall trellis configuration, or the ladder with central column configuration.

13. The plant support of claim 1, wherein the ladder with central column configuration includes the plurality of elongate members positioned in a substantially parallel relationship, ones of the apexes of the elongate members coupled to the apexes of adjacent ones of the elongate members with ones of the couplers, the couplers located along the central column, the plurality of elongate members extending radially from the central column.

14. The plant support of claim 13, wherein the plurality of apexes include sequentially alternating first apexes and second apexes, wherein the ladder with central column configuration includes the first apexes being rotatably coupled to the first apexes of at least two other ones of the elongate members and the second apexes being radially spaced from the central column and defining open volumes.

15. The plant support of claim 1, wherein the plurality of apexes include sequentially alternating first apexes and second apexes, wherein the cage configuration includes rotationally coupling the first apexes together and rotationally coupling the second apexes together to thereby form a lattice of cells defining openings for promoting plant growth and for physically accessing a plant growing within the cage.

16. The plant support of claim 1, wherein the plurality of elongate members have a plurality of bends that define the plurality of apexes, the plurality of apexes including first apexes located in a first plane along a first axis and second apexes located in the first plane and along a second axis that is substantially parallel to the first axis.

17. The plant support of claim 16, wherein the plurality of elongate members have a periodic waveform shape, the first and second apexes sequentially alternating along a length of the elongate member.

18. The plant support of claim 1, wherein the plurality of elongate members have a resilient configuration and are designed and configured to form a plant support that is configured to bend along a longitudinal axis of the plant support.

19. The plant support of claim 16, wherein one or more of the plurality of elongate members include one or more support members extending between ones of the first or second apexes.

20. The plant support of claim 1, wherein the plant support includes first and second modules, each of the first and second modules including ones of the plurality of elongate members and couplers, wherein the first and second modules are configured to be stacked to adjust a height of the plant support.

21. The plant support of claim 20, wherein each of the plurality of elongate members include transverse sections extending between the apexes, the plant support further comprising at least one module coupler configured to couple together the first and second modules, the module coupler having a first end configured to be coupled to the transverse section of one of the elongate members of the first module and then rotated about the transverse section to couple a second end of the module coupler to one of the apexes of one of the elongate members of the second module.

22. A plant support kit, comprising:
a plurality of elongate members having a plurality of bends that define a plurality of apexes, the plurality of apexes including first apexes located in a first plane along a first axis and second apexes located in the first plane and along a second axis that is substantially parallel to the first axis; and
a plurality of couplers configured to releasably and rotatably couple together at least two of the elongate members at the first or second apexes.

23. The plant support kit of claim 22, further comprising a plurality of wall trellis spacer assemblies, the assemblies including a spacer for positioning ones of the couplers away from a vertical support structure and a fastener for fastening the coupler and the spacer to the vertical support structure.

24. The plant support kit of claim 22, wherein ones of the elongate members have first ends configured to be inserted into soil and ones of the elongate members include second ends configured to be disposed at a top end of the plant support, wherein the kit further comprises a plurality of tubes configured to be slidably disposed over the second ends for coupling together the second ends of adjacent ones of the elongate members.

25. The plant support kit of claim 22, wherein the plurality of couplers include first couplers designed and configured for constructing a cage configuration or wall trellis configuration.

26. The plant support kit of claim 25, wherein the plurality of couplers include second couplers having a different configuration than the first couplers that are designed and configured for constructing a ladder with central column configuration.

27. A method of using a plant support, the plant support comprising a plurality of elongate members that each have a waveform shape including a plurality of apexes and a plurality of couplers, the method comprising:
constructing the plant support in a cage configuration by removably coupling together the elongate members by attaching ones of the couplers to the apexes of adjacent ones of the adjacent elongate members to form a substantially cylindrical cage configuration.

28. The method of claim 27, wherein in the cage configuration, the couplers define a plurality of columns of hinged connections, the method further comprising selectively transitioning the plant support from the cage configuration to a wall trellis configuration by decoupling two adjacent elongate members along one of the plurality of columns and adjusting a relative rotational position of adjacent ones of the plurality of elongate members.

29. The method of claim 27, wherein the plurality of apexes include sequentially alternating first apexes and second apexes, the method further comprising constructing the plant support in a ladder with central column configuration by coupling the first apexes to the first apexes of at least two other ones of the elongate members, the couplers being positioned along the central column and the second apexes being radially spaced from the central column.
